(19) United States
(12) Patent Application Publication
(10) Pub. No.: US 2007/0184150 A1
(43) Pub. Date: Aug. 9, 2007

(54) Liquefaction process

(75) Inventors: Swapnil Bhargava, Raleigh, NC (US); Malcolm Johal, Raleigh, NC (US)

Correspondence Address: NOVOZYMES NORTH AMERICA, INC., 500 FIFTH AVENUE, SUITE 1600, NEW YORK, NY, 10110, US

(73) Assignee: Novozymes North America,Inc., Franklinton, NC (US)

(21) Appl. No.: 11/629,370

(22) PCT Filed: Jul. 8, 2005
(86) PCT No.: PCT/US05/24698

§ 371 Date: Dec. 12, 2006

Related U.S. Application Data
(60) Provisional application No. 60/587,383, filed on Jul. 13, 2004.

(51) Int. Cl. A23F 3/16

(52) U.S. Cl. 426/52

(57) ABSTRACT

The present invention relates to a process of liquefying starch-containing material, with a bacterial alpha-amylase at a temperature in the range from 65-75° C. for 1 to 2 hours. The invention also relates to a process of producing a fermentation product, preferably ethanol, using the liquefaction process of the invention.

### FIELD OF THE INVENTION

The present invention relates to an improved process of liquefying starch-containing material suitable as a step in processes for producing syrups or fermentation products, preferably ethanol. The invention also relates to processes for producing a fermentation product, preferably ethanol, comprising liquefying starch-containing starting material in accordance with the liquefaction process of the invention.

### BACKGROUND OF THE INVENTION

Liquefaction is a well known process step in the art of producing syrups and fermentation products, such as ethanol, from starch-containing materials. During liquefaction starch is converted to shorter chains and less viscous dextrins. Generally liquefaction involves gelatinization of starch simultaneously with or followed by addition of alphaamylase.

WO 94/18314 discloses an oxidation stable Bacillus alpha-amylase variant used for starch liquefaction including jet cooking at 105-107° C. followed by secondary liquefaction at 95° C. for 90 minutes.

WO 99/19467 discloses using a Bacillus alpha-amylase variant for liquefaction of starch-containing material, wherein primary liquefaction is carried out at 105° C. for 5 minutes and secondary liquefaction is carried out at 95° C. at an initial pH of 5.5.

Even though liquefaction processes have been improved significantly there is still a need for improving liquefaction of starch-containing material suitable in syrups and fermentation product producing processes.

### SUMMARY OF THE INVENTION

The object of the present invention is to provide an improved process of liquefying starch-containing material suitable as a step in processes for producing syrups or fermentation products, such as especially ethanol. The invention also provides a fermentation product, preferably ethanol, producing process including a liquefaction process of the invention.

According to the first aspect the invention relates to a process of liquefying starch-containing material, comprising treating the starch-containing material with a bacterial alpha-amylase at a temperature in the range from 65-75° C. for 1 to 2 hours.

In a preferred embodiment, the liquefaction is carried out at around 70° C. for around 90 minutes. A liquefaction process of the invention may be carried out at pH 4.5-6.5, in particular at a pH between 5 and 6. The bacterial alpha-amylase may be any of the ones described in the section “Alpha-Amylases” below. Preferred alpha-amylases are derived from a strain of Bacillus.

In a second aspect the invention provides a process of producing ethanol from starch-containing material by fermentation, said process comprises:

(i) liquefying starch-containing material according to a liquefaction process of the invention;

(ii) saccharifying the mash obtained in step (i);

(iii) fermenting the material using a fermenting micro-organism.

The term “mash” is used for liquefied starch-containing material, such as liquefied whole grain. The saccharification and fermentation is carried out sequentially, or preferably simultaneously (SSF process). Optionally ethanol is recovery after fermentation.

### BRIEF DESCRIPTION OF THE INVENTION

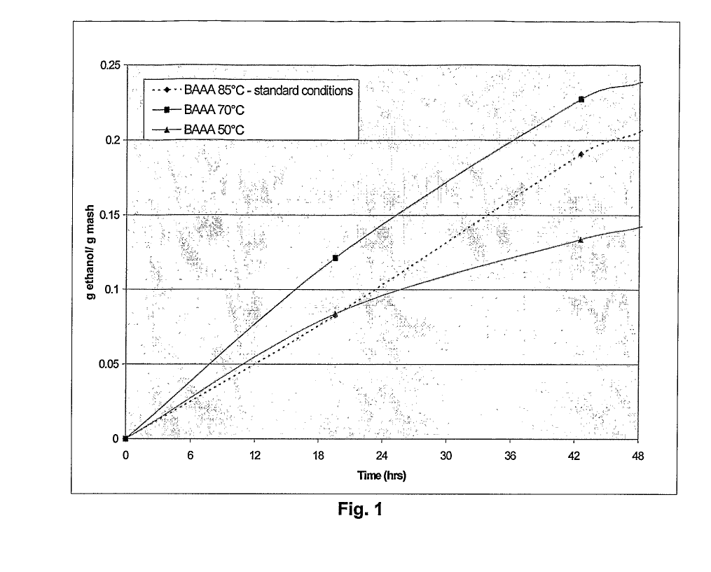

FIG. 1 shows the ethanol yields for temperature modified liquefactions (50° C., 70° C., and 85° C., respectively) after SSF.

### DESCRIPTION OF THE INVENTION

The present invention provides an improved liquefaction process suitable as a step in processes for producing fermentation products such as especially ethanol or syrups such as glucose or maltose. The invention also relates to a process of producing a fermentation product, preferably ethanol, comprising a liquefaction process of the invention. When the end product is ethanol it may be used as, e.g., fuel ethanol; drinking ethanol, i.e., potable neutral spirits; or industrial ethanol.

Liquefaction Process of the Invention

“Liquefaction” is a process in which starch-containing material is broken down (hydrolyzed) into maltodextrins (dextrins). Because the starch-containing material typically is heated to a temperature above the gelatinization temperature the liquefaction also helps the handling by thinning the starch-containing slurry. Liquefaction is usually carried out using a bacterial alpha-amylase at temperatures above 85° C. The inventors have surprisingly found that when decreasing the temperature during liquefaction to around 70° C. the ethanol yield after simultaneous saccharification and fermentation (SSF) was improved (see Example 1). The improved ethanol yield was obtained despite the fact that higher temperatures (such as 85° C.) increase the degree of gelatinization and in general increase reaction rate of bacterial alpha-amylases. By reducing the liquefaction temperature to around 70° C. it is believed that the enzyme kinetics may have been changed and consequently also the soluble sugar profile of the liquefied mash. The inventors found that more small fermentable sugars, in particular glucose and maltose, were produced during liquefaction at 70° C. than during liquefaction using the same alpha-amylase at 85° C. Another explanation might be that the chemical structures of starch and/or released sugars are changed. The released sugars might be modified at high temperatures, such as 85° C., while the released sugars may be in natural form at lower temperatures such as 70° C. At 85° C. the starch gelatinizes, forming a looser structure for the enzyme to access. At 70° C. the starch granules may be less accessible, resulting in that the enzyme can only hydrolyze sugar units from free ends. Consequently smaller sugars are produced.

According to the first aspect the invention relates to a process of liquefying starch-containing material, comprising treating starch-containing material with a bacterial alpha-amylase at a temperature in the range from 65-75° C. for 1 to 2 hours.

In a preferred embodiment the liquefaction is carried out at around 70° C. for around 90 minutes. A liquefaction process of the invention may be carried out at pH 4.5-6.5, in particular at a pH between 5 and 6. In one embodiment of the invention the starch-containing material is jet-cooked at 90-120° C., preferably around 105° C., for 1-15 minutes, preferably for 3-10 minute, especially around 5 minutes, prior to liquefaction with or without a bacterial alpha-amylase. It is to be understood that the process of the invention may also be carried out without a jet-cooking step. In one embodiment of the invention an aqueous slurry containing, preferably 10-40 wt-%, especially 25-35 wt-% starch-containing material, is prepared before liquefaction or before jet-cooking (if carried out). In a further embodiment of the liquefaction process of the invention 0.005-2 AGU/g DS, preferably 0.01-0.3 AGU/g DS, such as especially around 0.05 AGU/g DS, of glucoamylase may be added during liquefaction. The glucoamylase may be any glucoamylase including the ones mentioned in the “Glucoamylase”—section below.

Starch-Containing Material

The starch-containing material used according to the present invention may be any starch-containing material, preferably selected from the group consisting of: tubers, roots, and whole grain; and any combinations of the forgoing. In an embodiment, the starch-containing material is obtained from cereals. The starch-containing material may, e.g., be selected from the groups consisting of corns, cobs, wheat, barley, cassava, sorghum, rye, milo and potatoes; or any combination of the forgoing.

If the liquefaction process of the invention is included in an ethanol process of the invention, the raw starch-containing material is preferably whole grain or at least mainly whole grain. A wide variety of starch-containing whole grain crops may be used as raw material including: corn (maize), milo, potato, cassava, sorghum, wheat, and barley, or any combinations thereof. In a preferred embodiment the starch-containing material is whole grain selected from the group consisting of corn, wheat and barley, or any combinations thereof.

The raw material may also consist of or comprise a side-stream from starch processing, e.g., C₆ carbohydrate containing process streams that are not suitable for production of, e.g., syrups.

Milling

In a preferred embodiment of the invention the starch-containing material is reduced in size, preferably by milling before step (a), i.e., before the primary liquefaction in order to open up the structure and allowing for further processing. Thus, in a particular embodiment, the liquefaction process further comprises—prior to the primary liquefaction step—the steps of:

i. reducing the size of starch-containing material, such as whole grain, preferably by milling;

ii. forming a slurry comprising the milled starch-containing material and water.

Two processes of milling are normally used: wet and dry milling.

The term “dry milling” denotes milling of the whole grain. In dry milling the whole kernel is milled and used in the remaining part of the process. Wet milling gives a good separation of germ and meal (starch granules and protein) and is with a few exceptions applied at locations where there is a parallel production of syrups.

Dry milling is preferred in processes aiming at producing ethanol.

The term “grinding” is also understood as milling. In a preferred embodiment of the invention dry milling is used. However, it is to be understood that other methods of reducing the particle size of the starch-containing material are also contemplated and covered by the scope of the invention. Examples include technologies such as emulsifying technology, rotary pulsation may also be used.

Fermentation Product Producing Process

A fermentation product, preferably ethanol, production process of the invention generally involves the steps of liquefaction, saccharification, fermentation, and optionally recovering the product, preferably by distillation.

According to this aspect, the invention relates to a process of producing a fermentation product, preferably ethanol, from starch-containing material by fermentation, said process comprises the steps of:

(i) liquefying starch-containing material using a liquefaction process of the invention;

(ii) saccharifying the mash obtained in step (i)

(iii) fermenting the material using a fermenting micro-organism.

In an embodiment the saccharification and fermentation steps are carried out sequentially, preferably simultaneously (SSF process). In a preferred embodiment of the invention starch-containing raw material, such as whole grain, preferably corn, is dry milled in order to open up the structure and allow for further processing.

In a preferred embodiment a jet-cooking step, as defined above, is included before step (i).

In a preferred embodiment any of the bacterial alpha-amylases mentioned in the section “Alpha-Amylase” below may be used.

Saccharification

“Saccharification” is a step in which the maltodextrin (such as, product from the liquefaction) is converted to low molecular sugars DP₁₋₃ (i.e., carbohydrate source) that can be metabolized by a fermenting micro-organism, such as yeast. Saccharification is a well known step in the art and is typically performed enzymatically using at least one or more carbohydrate-source generating enzymes as will be described further below. The saccharification step comprised in the process for producing a fermentation product, preferably ethanol, of the invention may be a well known saccharification step in the art. In one embodiment glucoamylase, alpha-glucosidase and/or acid alpha-amylase is used for treating the liquefied material. A full saccharification step may last from 20 to 100 hours, preferably about 24 to about 72 hours, and is often carried out at temperatures from about 30 to 65° C., and at a pH between 4 and 6, normally around pH 4.5-5.0. However, it is sometimes more preferred to do a pre-saccharification step, lasting for about 40 to 90 minutes at temperature of between 30-65° C., typically about 60° C., followed by complete saccharification during fermentation in a simultaneous saccharification and fermentation process (SSF). The most widely used process in ethanol production is the simultaneous saccharification and fermentation (SSF) process. In general, there is no holding stage for the saccharification, meaning that fermenting micro-organism, such as yeast, and enzyme(s) is(are) added together. In SSF processes, it is common to introduce a pre-saccharification step at a temperature between 40 and 60° C., preferably around 50° C., just prior to the fermentation.

Fermentation

The term “fermenting micro-organism” refers according to the invention to any micro-organism suitable for use in a desired fermentation process. Suitable fermenting micro-organisms are capable of fermenting, i.e., converting sugars, such as glucose or maltose, directly or indirectly into the fermentation product, preferably ethanol, in question. Examples of fermenting micro-organisms include fungal organisms, such as yeast. Preferred yeast includes strains of Saccharomyces, in particular Saccharomyces cerevisiae. Commercially available yeast includes, e.g., RED STAR®/Lesaffre Ethanol Red (available from Red Star/Lesaffre, USA), SUPERSTART (available from Alltech), FALI (available from Fleischmann's Yeast, a division of Burns Philp Food Inc., USA), GERT STRAND (available from Gert Strand AB, Sweden) and FERMIOL (available from DSM Specialties). In preferred embodiments, yeast is applied to the saccharified material. Fermentation is ongoing for 24-96 hours, such as typically 35-65 hours. In preferred embodiments, the temperature is generally between 26-34° C., in particular about 32° C., and the pH is generally from pH 3-6, preferably around pH 4-5. Yeast cells are preferably applied in amounts of 10⁵ to 10¹², preferably from 10⁷ to 10¹⁰, especially 5×10⁷ viable yeast count per ml of fermentation broth. During the ethanol producing phase the yeast cell count should preferably be in the range from 10⁷ to 10¹⁰, especially around 2×10⁸. Further guidance in respect of using yeast for fermentation can be found in, e.g., “The alcohol Textbook” (Editors K. Jacques, T. P. Lyons and D. R. Kelsall, Nottingham University Press, United Kingdom 1999), which is hereby incorporated by reference.

Recovery of Fermentation Product

Optionally the fermentation product, preferably ethanol, is recovery after fermentation, preferably by including the step of:

(iv) distillation to obtain the fermentation product, preferably ethanol.

In an embodiment the fermentation in step (iii) and the distillation in step (iv) is carried out simultaneously or separately/sequential; optionally followed by one or more process steps for further refinement of the fermentation product, preferably ethanol.

Starch Conversion

The liquefaction process of the invention may also be included in a traditional starch conversion process for producing syrups such as glucose, maltose, malto-oligosaccharides and isomalto-oligosaccharides.

Bacterial Alpha-Amylases

According to the invention the bacterial alpha-amylase is preferably derived from the genus Bacillus.

In a preferred embodiment the Bacillus alpha-amylase is derived from a strain of B. licheniformis, B. amyloliquefaciens, B. subtilis or B. stearothermophilu, but may also be derived from other Bacillus sp. Specific examples of contemplated alpha-amylases include the Bacillus licheniformis alpha-amylase shown in SEQ ID NO: 4, the Bacillus amyloliquefaciens alpha-amylase SEQ ID NO: 5 and the Bacillus stearothermophilus alpha-amylase shown in SEQ ID NO: 3 in WO 99/19467 (all sequences hereby incorporated by reference). In an embodiment of the invention the alpha-amylase may be an enzyme having a degree of identity of at least 60%, preferably at least 70%, more preferred at least 80%, even more preferred at least 90%, such as at least 95%, at least 96%, at least 97%, at least 98% or at least 99% to any of the sequences shown in SEQ ID NOS: 1, 2 or 3, respectively, in WO 99/19467.

The Bacillus alpha-amylase may also be a variant and/or hybrid, especially one described in any of WO 96/23873, WO 96/23874, WO 97/41213, WO 99/19467, WO 00/60059, and WO 02/10355 (all documents hereby incorporated by reference). Specifically contemplated alpha-amylase variants are disclosed in U.S. Pat. Nos. 6,093,562, 6,297,038 or U.S. Pat. No. 6,187,576 (hereby incorporated by reference) and include Bacillus stearothermophilus alpha-amylase (BSG alpha-amylase) variants having a deletion of one or two amino acid in positions R179 to G182, preferably a double deletion disclosed in WO 1996/023873—see e.g., page 20, lines 1-10 (hereby incorporated by reference), preferably corresponding to delta(181-182) compared to the wild-type BSG alpha-amylase amino acid sequence set forth in SEQ ID NO:3 disclosed in WO 99/19467 or deletion of amino acids R179 and G180 using SEQ ID NO:3 in WO 99/19467 for numbering (which reference is hereby incorporated by reference). Even more preferred are Bacillus alpha-amylases, especially Bacillus stearothermophilus alpha-amylase, which have a double deletion corresponding to delta(181-182) and further comprise a N193F substitution (also denoted I181*+G182*+N193F) compared to the wild-type BSG alpha-amylase amino acid sequence set forth in SEQ ID NO:3 disclosed in WO 99/19467.

A hybrid alpha-amylase specifically contemplated comprises 445 C-terminal amino acid residues of the Bacillus licheniformis alpha-amylase (shown in SEQ ID NO: 4 of WO 99/19467) and the 37 N-terminal amino acid residues of the alpha-amylase derived from Bacillus amyloliquefaciens (shown in SEQ ID NO: 5 of WO 99/19467), with one or more, especially all, of the following substitutions: G48A+T49I+G107A+H156Y+A181T+N190F+I201F+A209V+Q264S (using the Bacillus licheniformis numbering in SEQ ID NO: 4 of WO 99/19467). Also preferred are variants having one or more of the following mutations (or corresponding mutations in other Bacillus alpha-amylase backbones): H154Y, A181T, N190F, A209V and Q264S and/or deletion of two residues between positions 176 and 179, preferably deletion of E178 and G179 (using the SEQ ID NO: 5 numbering of WO 99/19467).

The bacterial alpha-amylase may be added in amounts as are well-known in the art. When measured in KNU units (described below in the Materials & Methods”-section) the alpha-amylase activity is preferably present in an amount of 0.5-5,000 NU/g of DS, in an amount of 1-500 NU/g of DS, or more preferably in an amount of 5-1,000 NU/g of DS, such as 10-100 NU/g DS.

Carbohydrate-Source Generating Enzyme

The term “carbohydrate-source generating enzyme” includes glucoamylase (being glucose generators), beta-amylase and maltogenic amylase (being maltose generators). A carbohydrate-source generating enzyme is capable of providing energy to the fermenting micro-organism(s) used in a process of the invention for producing ethanol and/or may be converting directly or indirectly to a desired fermentation product, especially ethanol. The carbohydrate-source generating enzyme may be mixtures of enzymes falling within the definition. Especially contemplated mixtures are mixtures of at least a glucoamylase and an alpha-amylase, especially an acid alpha-amylase, even more preferred an acid fungal alpha-amylase. The ratio between acidic fungal alpha-amylase activity (AFAU) per glucoamylase activity (AGU) (AFAU per AGU) may in an embodiment of the invention be at least 0.1, in particular at least 0.16, such as in the range from 0.12 to 0.50.

Examples of contemplated glucoamylases, maltogenic amylases, and beta-amylases are set forth in the sections below.

Glucoamylase

A glucoamylase used according to the invention may be derived from any suitable source, e.g., derived from a microorganism or a plant. Preferred glucoamylases are of fungal or bacterial origin, selected from the group consisting of Aspergillus glucoamylases, in particular A. niger G1 or G2 glucoamylase (Boel et al. (1984), EMBO J. 3 (5), p. 1097-1102), or variants thereof, such as disclosed in WO 92/00381, WO 00/04136 add WO 01/04273 (from Novozymes, Denmark); the A. awamori glucoamylase (WO 84/02921), A. oryzae (Agric. Biol. Chem. (1991), 55 (4), p. 941-949), or variants or fragments thereof.

Other Aspergillus glucoamylase variants include variants to enhance the thermal stability: G137A and G139A (Chen et al. (1996), Prot. Eng. 9, 499-505); D257E and D293E/Q (Chen et al. (1995), Prot. Engng. 8, 575-582); N182 (Chen et al. (1994), Biochem. J. 301, 275-281); disulphide bonds, A246C (Fierobe et al. (1996), Biochemistry, 35, 8698-8704; and introduction of Pro residues in position A435 and S436 (Li et al. (1997), Protein Engng. 10, 1199-1204. Other glucoamylases include Athelia rolfsii (previously denoted Corticium rolfsii) glucoamylase (see U.S. Pat. No. 4,727,026 and (Nagasaka, Y. et al. (1998) Purification and properties of the raw-starch-degrading glucoamylases from Coricium rolfsii, Appl Microbiol Biotechnol 50:323-330), Talaromyces glucoamylases, in particular, derived from Talaromyces emersonii (WO 99/28448), Talaromyces leycettanus (U.S. Pat. No. Re. 32,153), Talaromyces duponti, Talaromyces thermophilus (U.S. Pat. No. 4,587,215). Bacterial glucoamylases contemplated include glucoamylases from the genus Clostridium, in particular C. thermoamylolyticum (EP 135,138), and C. thermohydrosulfuricum (WO 86/01831).

Commercially available compositions comprising glucoamylase include AMG 200L; AMG 300 L; SAN™ SUPER, SAN™ EXTRA L, SPIRIZYME™ PLUS, SPIRIZYME™ FUEL, SPIRIZYME™ B4U and AMG™ E (from Novozymes A/S); OPTIDEX™ 300 (from Genencor Int.); AMIGASE™ and AMIGASE™ PLUS (from DSM); G-ZYME™ G900, G-ZYME™ and G990 ZR (from Genencor Int.).

Glucoamylases may in an embodiment be added in an amount of 0.02-20 AGU/g DS, preferably 0.1-10 AGU/g DS, especially between 1-5 AGU/g DS, such as 0.5 AGU/g DS.

Beta-Aamylase

At least according to the invention the a beta-amylase (E.C 3.2.1.2) is the name traditionally given to exo-acting maltogenic amylases, which catalyze the hydrolysis of 1,4-alpha-glucosidic linkages in amylose, amylopectin and related glucose polymers. Maltose units are successively removed from the non-reducing chain ends in a step-wise manner until the molecule is degraded or, in the case of amylopectin, until a branch point is reached. The maltose released has the beta anomeric configuration, hence the name beta-amylase.

Beta-amylases have been isolated from various plants and microorganisms (W. M. Fogarty and C. T. Kelly, Progress in Industrial Microbiology, vol. 15, pp. 112-115, 1979). These beta-amylases are characterized by having optimum temperatures in the range from 40° C. to 65° C. and optimum pH in the range from 4.5 to 7. A commercially available beta-amylase from barley is NOVOZYM™ WBA from Novozymes A/S, Denmark and SPEZYME™ BBA 1500 from Genencor Int., USA.

Maltogenic Amylase

The amylase may also be a maltogenic alpha-amylase. A “maltogenic alpha-amylase” (glucan 1,4-alpha-maltohydrolase, E.C. 3.2.1.133) is able to hydrolyze amylose and amylopectin to maltose in the alpha-configuration. A maltogenic alpha-amylase from Bacillus stearothermophilus strain NCIB 11837 is commercially available from Novozymes A/S under the tradename MALTOGENASE™. Maltogenic alpha-amylases are described in U.S. Pat. Nos. 4,598,048, 4,604,355 and 6,162,628, which are hereby incorporated by reference.

The maltogenic amylase may in a preferred embodiment be added in an amount of 0.05-5 mg total protein/gram DS or 0.05-5 MANU/g DS.

Production of Enzymes

The enzymes referenced herein may be derived or obtained from any suitable origin, including, bacterial, fungal, yeast or mammalian origin. The term “derived” or means in this context that the enzyme may have been isolated from an organism where it is present natively, i.e., the identity of the amino acid sequence of the enzyme are identical to a native enzyme. The term “derived” also means that the enzymes may have been produced recombinantly in a host organism, the recombinant produced enzyme having either an identity identical to a native enzyme or having a modified amino acid sequence, e.g., having one or more amino acids which are deleted, inserted and/or substituted, i.e., a recombinantly produced enzyme which is a mutant and/or a fragment of a native amino acid sequence or an enzyme produced by nucleic acid shuffling processes known in the art. Within the meaning of a native enzyme are included natural variants. Furthermore, the term “derived” includes enzymes produced synthetically by, e.g., peptide synthesis. The term “derived” also encompasses enzymes which have been modified e.g., by glycosylation, phosphorylation, or by other chemical modification, whether in vivo or in vitro. The term “obtained” in this context means that the enzyme has an amino acid sequence identical to a native enzyme. The term encompasses an enzyme that has been isolated from an organism where it is present natively, or one in which it has been expressed recombinantly in the same type of organism or another, or enzymes produced synthetically by, e.g., peptide synthesis. With respect to recombinantly produced enzymes the terms “obtained” and “derived” refers to the identity of the enzyme and not the identity of the host organism in which it is produced recombinantly.

The enzymes may also be purified. The term “purified” as used herein covers enzymes free from other components from the organism from which it is derived. The term “purified” also covers enzymes free from components from the native organism from which it is obtained. The enzymes may be purified, with only minor amounts of other proteins being present. The expression “other proteins” relate in particular to other enzymes. The term “purified” as used herein also refers to removal of other components, particularly other proteins and most particularly other enzymes present in the cell of origin of the enzyme of the invention. The enzyme may be “substantially pure,” that is, free from other components from the organism in which it is produced, that is, for example, a host organism for recombinantly produced enzymes. In preferred embodiment, the enzymes are at least 75% (w/w) pure, more preferably at least 80%, at least 85%, at least 90%, at least 95%, at least 96%, at least 97%, at least 98%, or at least 99% pure. In another preferred embodiment, the enzyme is 100% pure.

The enzymes used according to the present invention may be in any form suitable for use in the processes described herein, such as, e.g., in the form of a dry powder or granulate, a non-dusting granulate, a liquid, a stabilized liquid, or a protected enzyme. Granulates may be produced, e.g., as disclosed in U.S. Pat. No. 4,106,991 and U.S. Pat. No. 4,661,452, and may optionally be coated by process known in the art. Liquid enzyme preparations may, for instance, be stabilized by adding stabilizers such as a sugar, a sugar alcohol or another polyol, lactic acid or another organic acid according to established process. Protected enzymes may be prepared according to the process disclosed in EP 238,216.

Even if not specifically mentioned in context of a method or process of the invention, it is to be understood that the enzyme(s) or agent(s) is(are) used in an “effective amount”.

Materials and Methods

Enzymes:

Bacterial Alpha-Amylase A: Bacillus stearothermophilus alpha-amylase variant with the mutations: I181*+G182*+N193F disclosed in U.S. Pat. No. 6,187,576 and available on request from Novozymes A/S, Denmark.
Glucoamylase TN: Glucoamylase derived from Talaromyces emersonii and disclosed as SEQ ID NO: 7 in WO 99/28448 with side activity of Aspergillus niger glucoamylase and Aspergillus niger acid alpha-amylase.
   Yeast
Red Star™ available from Red Star/Lesaffre, USA
   Methods:
   Alpha-Amylase Activity (KNU)

The amylolytic activity may be determined using potato starch as substrate. This method is based on the break-down of modified potato starch by the enzyme, and the reaction is followed by mixing samples of the starch/enzyme solution with an iodine solution. Initially, a blackish-blue color is formed, but during the break-down of the starch the blue color gets weaker and gradually turns into a reddish-brown, which is compared to a colored glass standard.

One Kilo Novo alpha-amylase Unit (KNU) is defined as the amount of enzyme which, under standard conditions (i.e., at 37° C.±0.05; 0.0003 M Ca²⁺; and pH 5.6) dextrinizes 5260 mg starch dry substance Merck Amylum solubile.

A folder EB-SM-0009.02/01 describing this analytical method in more detail is available upon request to Novozymes A/S, Denmark, which folder is hereby included by reference.

Glucoamylase Activity (AGU)

The Novo Glucoamylase Unit (AGU) is defined as the amount of enzyme, which hydrolyzes 1 micromole maltose per minute under the standard conditions 37° C., pH 4.3, substrate: maltose 23.2 mM, buffer: acetate 0.1 M, reaction time 5 minutes.

An autoanalyzer system may be used. Mutarotase is added to the glucose dehydrogenase reagent so that any alpha-D-glucose present is turned into beta-D-glucose. Glucose dehydrogenase reacts specifically with beta-D-glucose in the reaction mentioned above, forming NADH which is determined using a photometer at 340 nm as a measure of the original glucose concentration.

| | |
|---|---|
| AMG incubation: | |
| Substrate: | maltose 23.2 mM |
| Buffer: | acetate 0.1 M |
| pH: | 4.30 ± 0.05 |
| Incubation temperature: | 37° C. ± 1 |
| Reaction time: | 5 minutes |
| Enzyme working range: | 0.5-4.0 AGU/mL |
| Color reaction: | |
| GlucDH: | 430 U/L |
| Mutarotase: | 9 U/L |
| NAD: | 0.21 mM |
| Buffer: | phosphate 0.12 M; 0.15 M NaCl |
| pH: | 7.60 ± 0.05 |
| Incubation temperature: | 37° C. ± 1 |
| Reaction time: | 5 minutes |
| Wavelength: | 340 nm |

A folder (EB-SM-0131.02/01) describing this analytical method in more detail is available on request from Novozymes A/S, Denmark, which folder is hereby included by reference.

Determination of Identity

For purposes of the present invention, the degree of identity between two amino acid sequences is determined by the Clustal method (Higgins, 1989, CABIOS 5: 151-153) using the LASERGENE™ MEGALIGN™ software (DNASTAR, Inc., Madison, Wis.) with an identity table and the following multiple alignment parameters: Gap penalty of 10, and gap length penalty of 10. Pairwise alignment parameters were Ktuple=1, gap penalty=3, windows=5, and diagonals=5].

### EXAMPLES

### Example 1

Ethanol yields from Bacterial Alpha-Amylase A Liquefaction at Different Temperatures

To investigate the effect of bacterial liquefaction enzymes on SSF, 3 different conditions for liquefaction were tested. To begin with ground corn was used to make 30% slurry with tap water. The pH in all the liquefactions was adjusted to 5.4 using diluted H₂SO₄. Table 1 shows the temperatures and times for the liquefaction conditions using Bacterial Alpha-Amylase A (BAAA) at a concentration of 50 NU/g DS. Once the liquefaction was complete, the reactions were stopped by adding 2 drops of HCl (4 N). Samples were withdrawn to analyze sugar profiles.

TABLE 1
Liquefaction conditions for Bacterial Alpha-Amylase
A (BAAA) temperature study

| | Bacterial Alpha-Amylase A | 1.5 hour |
|---|---|---|
| Liquefaction | (NU/g) | Temperature (° C.) |
| 1 | 50 | 85 |
| 2 | 50 | 70 |
| 3 | 50 | 50 |

The effect of liquefaction treatment on SSF was evaluated via mini-scale fermentations. After liquefaction the pH was adjusted to 5.0 with diluted NaOH. Approximately 4 g of mash was added to 16 ml polystyrene tubes (Falcon 352025). Tubes were then dosed with 0.5 AGU g DS Glucoamylase TN. After dosing the tubes with enzyme they were inoculated with 0.04 ml/g mash of yeast propagate (RED STAR™) that had been grown for 21 hours on corn mash. Vials were capped with a screw on lid which had been punctured with a very small needle to allow gas release and vortexed briefly before weighing and incubation at 32° C. Fermentation progress was followed by weighing the tubes over time. Tubes were vortexed briefly before each weighing. Weight loss values were converted to ethanol yield (g ethanol/g DS) by the following formula:

$$g ethanol / g DS = \frac{\begin{matrix}g {CO}_{2} weight loss \times \frac{1 mol {CO}_{2}}{44.0098 g {CO}_{2}} \times \\ \frac{1 mol ethanol}{1 mol {CO}_{2}} \times \frac{46.094 g ethanol}{1 mol ethanol}\end{matrix}}{g corn in tube \times \% DS of corn}$$

After fermentation, one replicate was sacrificed for HPLC analysis for remaining sugar concentration and ethanol yield. Approximately 1 ml of cleared supernatant was passed through a 0.45 micro M filter to remove solids. A 1/10 dilution of this sample was analyzed by HPLC for glucose, maltose, maltotriose, larger soluble sugars (DP₄₊), and ethanol.

The results show that 70° C. liquefaction produces ethanol at a faster rate than the standard 85° C. liquefaction material. At 42 hours there is a 20% higher ethanol level using the 70° C. liquefied corn mash. Post fermentation HPLC analysis (Table 2) shows almost complete utilization of glucose for the 70° C. liquefaction, whereas the other liquefactions have about 40-60 g/l glucose remaining.

TABLE 2
Post fermentation HPLC data for temperature
modified liquefaction treatments

| | Dextrin | Maltotriose | Maltose | |
|---|---|---|---|---|
| Liquefaction treatment | (DP4)+ | (DP3) | (DP2) | Glucose |
| BAAA - 85° C. | 18.93 | 1.04 | 2.84 | 58.04 |
| BAAA - 70° C. | 17.21 | 3.49 | 5.37 | 0.79 |
| BAAA - 50° C. | 13.30 | 0.81 | 1.82 | 41.12 |

Ethanol yields from the fermentations were analyzed by weight loss due to CO₂ release (see FIG. 1). Final yields at around 50 hours were found to be 0.143, 0.239, 0.206 g of ethanol/g of mash successively for 50, 70 and 85° C. liquefaction treatments, showing an increase of approximately 16% at 70° C. compared to the standard process (85° C.).

1-17. (canceled)

18. A process of liquefying starch-containing material, wherein the process comprises treating starch-containing material with a bacterial alpha-amylase at a temperature in the range from 65-75° C. for 1 to 2 hours.

19. The process of claim 18, wherein the starch-containing material is selected from the group consisting of corn, cob, wheat, barley, rye, milo and potatoes; or any combination of these.

20. The process of claim 18, further comprising the steps of:
(a) reducing the size of starch-containing material;
(b) forming a slurry comprising the starch-containing material and water prior to liquefying the starch-containing material.

21. The process of claim 20, wherein alpha-amylase is added to the aqueous slurry.

22. The process of claim 20, wherein the milling step is a dry milling step or a wet milling step.

23. The process of claim 18, wherein the bacterial alpha-amylase is a Bacillus alpha-amylase.

24. The process of claim 23, wherein the Bacillus alpha-amylase is a Bacillus stearothermophilus alpha-amylase.

25. The process of claim 24, wherein the alpha-amylase is a variant of the Bacillus stearothermophilus alpha-amylase with the following mutations: I181*+G182*.

26. The process of claim 24, wherein the alpha-amylase is a variant of the Bacillus stearothermophilus alpha-amylase with the following mutations: I181*+G182*+N193F.

27. The process of claim 18, wherein the starch-containing material is jet-cooked at 90-120° C. for 1-15 minutes before liquefaction.

28. The process of claim 18, further wherein 0.005-2 AGU/g DS of glucoamylase is present during liquefaction.

29. A process of producing a fermentation product from starch-containing material by fermentation, said process comprises:
(a) liquefying starch-containing material as defined in claim 18;
(b) saccharifying the mash obtained in step (a);
(c) fermenting the material using a fermenting micro-organism.

30. The process of claim 29, further comprising recovery of the fermentation product.

31. The process of claim 29, wherein the saccharification and fermentation is carried out sequentially or simultaneous (SSF process).

32. The process of claim 29, wherein the fermenting micro-organism in step (c) is derived from Saccharomyces cerevisiae.

33. The process of claim 29, wherein the fermentation is carried out in the presence of a carbohydrate-source generating enzyme.

34. The process of claim 33, wherein the carbohydrate-source generating enzyme is a glucoamylase.

35. The process of claim 34, wherein the glucoamylase is derived from a strain of Aspergillus, Talaromyces, or Athelia.

36. The process of claim 35, wherein the glucoamylase is derived from a strain of Aspergillus niger, Aspergillus oryzae, Talaromyces emersonii or Athelia rolfsii.

37. The process according to 29, wherein the fermentation product is ethanol.
